(19) United States
(12) Patent Application Publication
(10) Pub. No.: US 2011/0145655 A1
(43) Pub. Date: Jun. 16, 2011

(54) INPUT/OUTPUT HUB TO INPUT/OUTPUT DEVICE COMMUNICATION

(76) Inventors: Mike ERICKSON, Fort Collins, CO (US); David MACIOROWSKI, Longmont, CO (US)

(21) Appl. No.: 12/635,894

(22) Filed: Dec. 11, 2009

(51) Int. Cl. G06F 13/42; G06F 13/00; G06F 11/07

(52) U.S. Cl. 714/43; 710/105; 710/302; 714/E11.024

(57) ABSTRACT

Example apparatus and methods virtualize a circuit disposed between an input/output (I/O) hub and an I/O device. The I/O hub is configured to communicate PCIe slot control and status signals with an I/O device via an interface. The example apparatus and methods selectively intercept and transform signals passing between the I/O hub and the I/O device. The example apparatus and methods may also provide intercepted signals to a sideband monitor.

### BACKGROUND

An input/output (I/O) hub in a computer (e.g., server) may interact with an I/O device. The I/O hub can be, for example, a southbridge implemented in an Intel 82801 chip. One skilled in the art will appreciate that other I/O hubs are available. The I/O hub is used to connect to and to control I/O devices. An I/O device may be, for example, a Peripheral Component Interconnect Express (PCIe) device. The I/O device may be connected to the I/O hub by an electrical interface associated with a PCIe slot. PCIe devices can be hot swapped in and/or out of a computer. Conventionally, a computer I/O hub has expected a specific interface over which specific signals (e.g., slot status, slot control) and power are communicated. The PCIe slot may also provide presence signals (e.g., doorbell signal, latch indicator). Conventionally these signals have been provided directly to the computer I/O hub and thus have not been easily captured.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates one embodiment of an apparatus disposed between an I/O hub and an I/O device.

FIG. 2 illustrates one embodiment of an apparatus disposed between an I/O hub and an I/O device, the apparatus interacting with an external management logic.

FIG. 3 illustrates one embodiment of a method for performing sideband processing of communications between a computer I/O hub and an I/O device.

### DETAILED DESCRIPTION

Example apparatus and methods support customizing connectivity between an I/O hub and a peripheral device. In one example, the peripheral device is a PCIe I/O device while in another example the peripheral device is not a PCIe device. In one embodiment, apparatus and methods support PCIe native communications and operations (e.g., hot swapping). In one embodiment, apparatus and methods may also support ACPI-mediated hot-plug modes. ACPI refers to the Advanced Configuration and Power Interface. Example apparatus and methods facilitate sideband intercepting and monitoring of signals passed between the I/O hub and the peripheral device. Example apparatus and methods may also provide direct access by an external logic (e.g., management logic) that can not only intercept signals but can also take actions including manipulating, testing, storing, and reporting signals.

The following includes definitions of selected terms employed herein. The definitions include various examples and/or forms of components that fall within the scope of a term and that may be used for implementation. The examples are not intended to be limiting. Both singular and plural forms of terms may be used within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

Some portions of the detailed descriptions that follow are presented in terms of algorithms and symbolic representations of operations on data bits within a memory. These algorithmic descriptions and representations are used by those skilled in the art to convey the substance of their work to others. An algorithm, here and generally, is conceived to be a sequence of operations that produce a result. The operations include physical manipulations of physical quantities. Usually, though not necessarily, the physical quantities take the form of electrical or magnetic signals capable of being stored, transferred, combined, compared, and otherwise manipulated in a logic, and so on. The physical manipulations transform electronic components and/or data from one state to another.

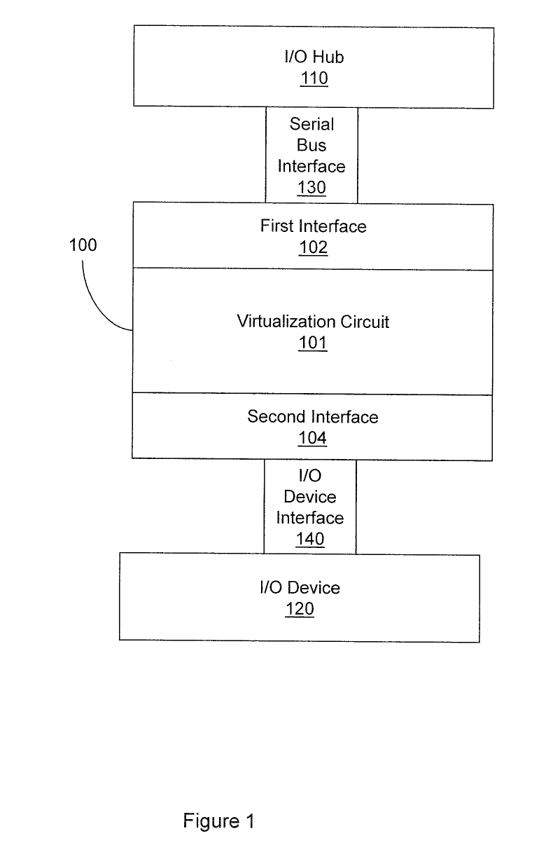

FIG. 1 illustrates one embodiment of an apparatus 100 disposed between an I/O hub 110 and an I/O device 120. Apparatus 100 includes a first interface 102 that is configured to communicate first electrical signals with the I/O hub 110 via an interface 130. The first electrical signals will be transmitted over the interface 130 according to a first protocol. The protocol can dictate signal amplitudes, signal timing, signal frequencies, and other signal attributes. The I/O hub 110 may be, for example, a southbridge implemented in an Intel 82801 chip.

Apparatus 100 includes a second interface 104. The second interface 104 is configured to communicate second electrical signals with an I/O device 120. The second electrical signals will be communicated via an I/O device interface 140 according to a second protocol. The second electrical signals can include control signals, status signals, and other signals. Conventionally, the I/O hub 110 would be directly connected to the I/O device 120 through the interface 130 and the I/O device interface 140. This direct and uninterrupted connection limited visibility into the signals being passed between the I/O hub 110 and the I/O device 140.

Apparatus 100 also includes a virtualization circuit 101. Virtualization circuit 101 provides an opportunity to intercept signals. Once the signals have been intercepted, they can be viewed, manipulated, stored, and subjected to other processes by, for example, a sideband monitor. Virtualization circuit 101 is configured to transform the first electrical signals to the second electrical signals. The first electrical signals are formatted to comply with the first protocol and the second electrical signals are formatted to comply with the second protocol. By disposing the virtualization circuit 101 between the interface 130 and the I/O device interface 140, the interface 130 and the I/O device interface 140 no longer have to be one hundred percent compatible with each other, or identical to each other. Instead, compatibility with the interface 130 can be handled by one side of the apparatus 100 and compatibility with the I/O device interface 140 can be handled by another side of apparatus 100. Virtualization circuit 101 can perform transformations as desired. The transformations can include, for example, changing signal amplitudes, changing signal timing, changing signal frequencies, and changing other signal attributes.

I/O devices can be added to and removed from a system. It is undesirable to shut down a system to add or remove an I/O device. Therefore, in one embodiment, the virtualization circuit 101 is configured to support hot-swapping the I/O device 120. In different embodiments, virtualization circuit 101 can support native PCIe hot swapping and/or ACPI-mediated hot swapping. Therefore, the virtualization circuit 101 can be configured to control the first interface 102 and/or the second interface 104 to adhere to an ACPI mediated protocol.

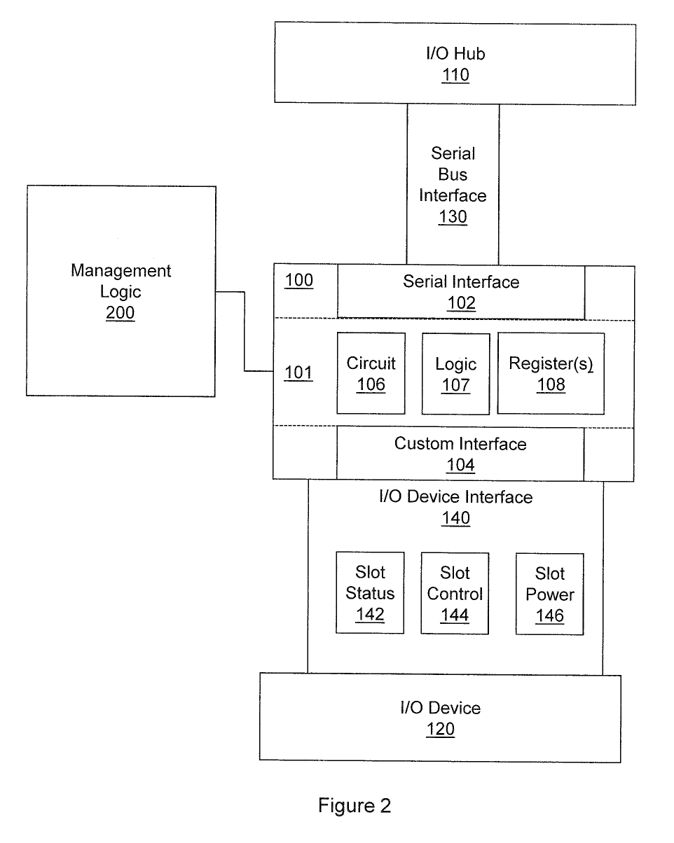

FIG. 2 illustrates one embodiment of apparatus 100 disposed between I/O hub 110 and I/O device 120. In this embodiment, apparatus 100 is illustrated interacting with an external management logic 200. The external management logic 200 can provide sideband monitoring and/or control. In this embodiment, the virtualization circuit 101 is configured to provide first signals passing through the first interface 102 to the external logic 200. Virtualization circuit 101 can, additionally and/or alternatively, be configured to provide second signals passing through the second interface 104 to the external logic 200.

In the embodiment of apparatus 100 illustrated in FIG. 2, the first interface 102 is illustrated as a serial interface 102 and the second interface 104 is illustrated as a custom interface 104. One skilled in the art will appreciate that while serial bus interface 130 is unlikely to change it is likely that new and different I/O devices and other peripheral devices will appear. Therefore configuring apparatus 100 with a custom interface 104 facilitates adapting to new and different I/O devices that may operate with interfaces that differ from interface 130.

The virtualization circuit 101 can also be configured to receive modified first signals from the external logic 200 and/or to receive modified second signals from the external logic 200. Therefore, the virtualization circuit 101 provides visibility to signals traversing apparatus 100 and provides an opportunity for external logic 200 to view, manipulate, store or otherwise process the signals traversing apparatus 100.

In one embodiment, an apparatus can include both apparatus 100 and external logic 200. External logic 200 can be configured to perform different actions. The actions can include, but are not limited to, performing sideband monitoring of signals passing through the virtualization circuit 101, storing the first signals, storing information about the first signals, modifying the first signals, modifying the first signals in response to a user input, performing a diagnostic test on the first signals, providing replacement first signals, and providing first signals that originate in the external logic 200. Therefore the virtualization circuit 101 and the external logic 200 facilitate viewing, controlling, manipulating, and even simulating signals outbound from the I/O hub 100.

External logic 200 can, additionally and/or alternatively, be configured to perform actions including, but not limited to, storing the second signals, storing information about the second signals, modifying the second signals, modifying the second signals in response to a user input, performing a diagnostic test on the second signals, providing replacement second signals, and providing second signals that originate in the external logic 200. Therefore the virtualization circuit 101 and the external logic 200 facilitate viewing, controlling, manipulating, and even simulating signals inbound from the I/O device 120. In one example, since inbound signals from I/O device 120 are available to virtualization circuit 101 and external logic 200 before they are available to I/O hub 110, diagnostics can be run on the signals before exposing the I/O device 120 to the I/O hub 110. This may prevent system crashes attributable to I/O device errors.

In different embodiments, external logic 200 can be configured to control the virtualization circuit 101 to control either or both of the first interface 102 and the second interface 104 to perform according to an ACPI-mediated method. The second interface can include, for example, a slot status component 142, a slot control component 144, and a power component 146. Therefore, in this embodiment, the virtualization circuit 101 is configured to transform signals representing slot status, slot control, and power on the I/O device 120 into signals representing slot status, slot control, and power on the I/O hub 110. The slot status component 142 can be, for example, a parallel to serial interface that is serial on the edge connected to the apparatus 100. The slot control component 144 can be, for example, a serial to parallel component that is serial on the edge connected to the apparatus 100. One skilled in the art will appreciate that other types of slot status components 142, slot status components 144, and slot power components 146 can be associated with an I/O device 120 or an I/O device interface 140.

One skilled in the art will appreciate that the virtualization circuit 101 can be implemented in different ways. The virtualization circuit 101 can be, for example, an application specific integrated circuit (ASIC), a field programmable gate array (FPGA), or other type of circuit. One skilled in the art will also appreciate that virtualization circuit 101 can include different elements. For example, virtualization circuit 101 can include a circuit 106, a logic 107, registers 108, and other elements. The logic 107 can be implemented as hardware, firmware, software in execution, and combinations thereof.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional, not illustrated blocks.

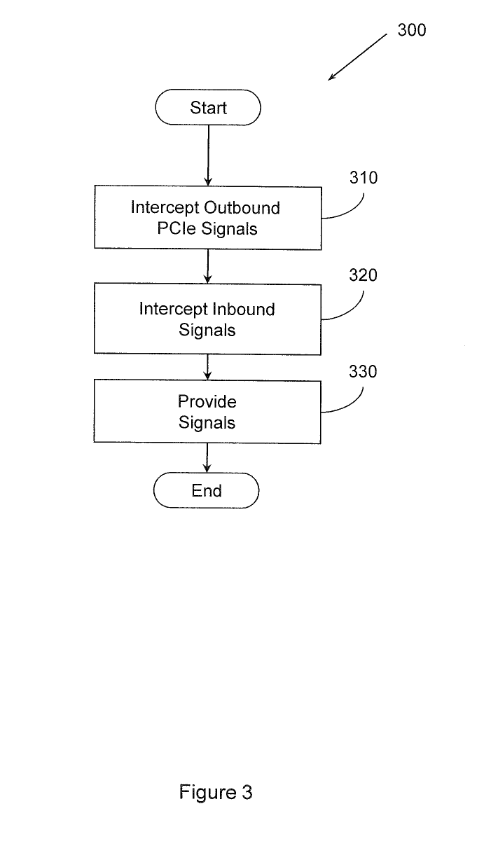

FIG. 3 illustrates one embodiment of a method 300 for providing sideband monitoring of communications between a computer I/O hub and a device. Method 300 can include, at 310, controlling a circuit to intercept outbound signals passing from a computer I/O hub to an I/O device via a first interface. The first interface can be, for example, a PCIe compliant serial bus interface. The computer I/O hub can be, for example, a server I/O hub. The I/O device can be, for example, a communications device.

Method 300 can also include, at 320, controlling the circuit to intercept inbound signals passing from the I/O device to the computer I/O hub via a second interface. The inbound signals can include PCIe compliant signals and/or non-PCIe compliant signals.

Method 300 can also include, at 330, providing the intercepted inbound and/or outbound signals to a sideband monitor. The sideband monitor may then process the signals, analyze the signals, store the signals, report the signals, and so on.

The sideband monitor can be controlled to store the outbound signals, to store information about the outbound signals, to perform a diagnostic test on the outbound signals, and to provide outbound signals that originate in the management processor.

The sideband monitor can also be controlled to process inbound signals. For example, the sideband monitor can store the inbound signals, store information about the inbound signals, perform a diagnostic test on the inbound signals, and provide inbound signals originating in the management processor.

More generally, apparatus 100 and method 300 provide means for virtualizing a circuit disposed between an I/O hub and an I/O device. The I/O hub is configured to send and receive PCIe signals. Apparatus 100 and method 300 also provide means for selectively intercepting and analyzing the signals. The means can be implemented in computer hardware, in circuits, in programmable devices (e.g., FPGA), in dedicated circuits (e.g., ASIC), in software controlled processors, and combinations thereof.

While example systems, methods, and apparatus on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. An apparatus, comprising:
a first interface configured to communicate first electrical signals with an input/output (I/O) hub via an interface according to a first protocol;
a second interface configured to communicate second electrical signals with an I/O device via an I/O device interface according to a second protocol; and
a virtualization circuit configured to transform the first electrical signals that are formatted to comply with the first protocol to the second electrical signals that are formatted to comply with the second protocol,

2. The apparatus of claim 1, where the virtualization circuit is configured to control a sideband monitor to monitor one or more of, the first electrical signals, and the second electrical signals.

3. The apparatus of claim 1, where the virtualization circuit is configured to support hot-swapping the I/O device.

4. The apparatus of claim 3, where hot-swapping the I/O device includes one of, PCIe native hot swapping, and ACPI-mediated hot swapping.

5. The apparatus of claim 1, the virtualization circuit being configured to perform one or more of:
providing first signals passing through the first interface to an external logic;
providing second signals passing through the second interface to the external logic;
receiving modified first signals from the external logic; and
receiving modified second signals from the external logic.

6. The apparatus of claim 5, the virtualization circuit being configured to control one or more of, the first interface, and the second interface to operate in accordance with an Advanced Configuration and Power Interface (ACPI) mediated protocol.

7. The apparatus of claim 6, comprising the external logic,
where the external logic is configured to perform one or more of,
sideband monitoring of signals passing through the virtualization circuit, storing the first signals, storing information about the first signals, performing a diagnostic test on the first signals, providing replacement first signals, and providing external logic initiated first signals,
storing the second signals, storing information about the second signals, performing a diagnostic test on the second signals, providing replacement second signals, and providing external logic initiated second signals,
and
performing a diagnostic test on a combination of the first signals and the second signals.

8. The apparatus of claim 7, the external logic being configured to control the virtualization circuit to control one or more of, the first interface and the second interface to operate according to an ACPI-mediated method.

9. The apparatus of claim 1, the virtualization circuit being one of, an application specific integrated circuit (ASIC), and a field programmable gate array (FPGA).

10. The apparatus of claim 1, the second interface comprising:
a slot status component;
a slot control component; and
a power component,
and
where the virtualization circuit is configured to transform signals representing slot status, slot control, and power on the I/O device into signals representing slot status, slot control, and power on the I/O hub.

11. The apparatus of claim 10,
where the slot status component is a parallel to serial interface that is serial on the edge connected to the apparatus, and
where the slot control component is a serial to parallel component that is serial on the edge connected to the apparatus.

12. A method, comprising:
controlling a circuit to intercept outbound PCIe slot control and status signals passing from a computer I/O hub to an I/O device via a first interface;
controlling the circuit to transform the outbound PCIe slot control and status signals to outbound slot control and status signals, where the outbound slot control and status signals are configured to be transmitted to the I/O device via the second interface;
controlling the circuit to intercept inbound slot control and status signals passing from the I/O device to the computer I/O hub via a second interface;
controlling the circuit to transform the inbound slot control and status signals into inbound PCIe slot control and status signals, where the inbound PCIe slot control and status signals are configured to be transmitted to the compound I/O hub via the first interface;
and
controlling the circuit to provide the inbound PCIe slot control and status signals to the computer I/O hub via the first interface and to provide the outbound slot control and status signals to the I/O device via the second interface.

13. The method of claim 12, comprising:
controlling the circuit to control the I/O device according to an ACPI-mediated protocol by manipulating one or more of, the outbound PCIe slot control and status signals, the outbound signals, the inbound signals, and the inbound PCIe slot control and status signals.

14. The method of claim 12, comprising:
controlling a management processor to perform one or more of,
sideband monitoring of signals passing through the circuit,
storing the outbound signals, storing information about the outbound signals, modifying the outbound signals, performing a diagnostic test on the outbound signals, and providing outbound signals originating in the management processor,
storing the outbound PCIe slot control and status signals, storing information about the outbound PCIe slot control and status signals, modifying the outbound PCIe slot control and status signals, performing a diagnostic test on the outbound PCIe slot control and status signals, and providing outbound PCIe slot control and status signals originating in the management processor,
storing the inbound signals, storing information about the inbound signals, modifying the inbound signals, performing a diagnostic test on the inbound signals, and providing inbound signals originating in the management processor,
storing the inbound PCIe slot control and status signals, storing information about the inbound PCIe slot control and status signals, modifying the inbound PCIe slot control and status signals, performing a diagnostic test on the inbound PCIe slot control and status signals, and providing inbound PCIe slot control and status signals originating in the management processor.

15. A system, comprising:
means for virtualizing a circuit disposed between an I/O hub configured to send and receive PCIe slot control and status signals and an I/O device; and
means for selectively intercepting and transforming the PCIe slot control and status signals.
